(19) United States
(12) Patent Application Publication
(10) Pub. No.: US 2020/0056528 A1
(43) Pub. Date: Feb. 20, 2020

(54) Line Assembly

(71) Applicant: NORMA Germany GmbH, Maintal (DE)

(72) Inventor: Janusz Szwajkosz, Slawniów, Pilica (PL)

(21) Appl. No.: 16/606,888

(22) PCT Filed: Mar. 22, 2018
(86) PCT No.: PCT/EP2018/057362

§ 371 Date: Oct. 21, 2019

(30) Foreign Application Priority Data
Apr. 21, 2017 (DE) 10 2017 108 532.7

(51) Int. Cl. F01N 3/20; F16L 53/38; F16L 53/32; F16L 11/08; F16L 11/118; B32B 5/02; B32B 1/08

(52) U.S. Cl. CPC F01N 3/208; F16L 53/38; F16L 53/32; F16L 11/085; F16L 11/118; B32B 2597/00; B32B 5/024; B32B 1/08; F01N 2610/02; F01N 2610/10; F01N 2610/14; F01N 3/2066

(57) ABSTRACT

The disclosure relates to a line assembly for a liquid or gaseous medium, including at least one first line, which is designed as a UREA line, and including a second line for a liquid or gaseous medium. The first line and the second line are thermally coupled to each other. According to examples, the first line is wrapped around the second line or the second line is wrapped around the first line.

The disclosure relates to a line assembly having at least one first line, which is realized as a UREA line, and having a second line for a liquid or gaseous medium.

Line assemblies having a first and a second line are disclosed in the prior art for various applications. Thus, coolant lines, which conduct a liquid medium, are used for heat dissipation. Relatively large-volume lines, through which hot exhaust gases are removed from the engine, are used, in contrast, in particular in the exhaust gas system.

In particular for emissions saving in the case of diesel engines, systems are often used for exhaust gas treatment where UREA, that is to say a urea solution, is injected. Due to legal regulations, however, it is necessary, even in the case of low temperatures at which UREA usually freezes, to carry out an exhaust gas treatment. Consequently, it is usual to heat the UREA lines by means of electric heating elements which are either wound around the UREA lines on the outside in the form of heating wires or extend in the interior of the UREA line.

Such a design is disclosed, for example, in US 2008 202 616 A1 or US 2011 262 310 A1, one or multiple electric heating wires being wound around a line having a liquid or gaseous medium. For heating purposes, a voltage is applied to the wires, as a result of which the heating wires are heated. Said assemblies only enable a fluid to be heated and require an additional energy supply. An electric power source is therefore always necessary for heating the fluid.

### SUMMARY

It is one object of the disclosure to provide a line assembly which enables reliable heating of UREA in the first line in a motor vehicle even without an additional electric power supply.

The above-named object is achieved according to an embodiment by a line assembly having at least one first line, which is realized as a UREA line, and having a second line for a liquid or gaseous medium as a result of the first line and the second line being thermally coupled together, wherein the first line is wound around the second line or the second line is wound around the first line.

The line assembly enables the UREA line to be heated by the medium in the second line without additional electric energy. In this case, a temperature exchange between the media flowing through the lines can be effected over a longer section and consequently over a longer time period as a result of winding the one line with the other line.

The second line preferably, in an embodiment, comprises a greater diameter than the first line, wherein the diameter of the second line corresponds, in particular, to more than four times, in particular to more than eight times or to more than ten times the diameter of the first line. The medium in the second line can thus occupy a very much larger volume compared to the UREA in the first line and can accordingly transport more thermal energy. Consequently, sufficient thermal energy is available for heating the UREA so that rapid heating can be ensured.

With the second line having a relatively large cross section compared to the cross section of the first line, hot exhaust gas from an internal combustion engine could be conducted through the second line and thus heat the UREA in the first line. In particular, when the diameters of the second line are not so large, liquid media, such as cooling water of the motor vehicle, can flow through the second line. Cooling water is heated relatively rapidly during the operation of the internal combustion engine and can then output sufficient thermal energy to the UREA conducted in the first line. Additional heating of the UREA in the first line is then as a rule not necessary.

For example, the first line is wound in a spiral or helical manner around the second line. As a result of regular winding, the UREA is heated or cooled in a uniform manner in the first line. In addition, the length of the first line and consequently the duration of the temperature exchange can be defined as a result of the gradient of the spiral or helical line.

A woven fabric which holds the first line on the second line can be provided as an option. The woven fabric therefore fixes the first line on the second line in a desired position. In addition, the woven fabric can protect at least the first line against environmental influences such as mechanical stress.

The first line can also be interwoven with the woven fabric in order, in this way, to enable direct fixing of the first line on the second line.

The woven fabric is, in particular, a glass-fiber fabric which provides sufficient stability and is simple to process. In addition, a glass-fiber fabric is not sensitive to temperature and can consequently be used over a large temperature range.

A protective jacket, which surrounds the first line and the second line and, where applicable, the woven fabric, can be provided as an option. The protective jacket provides protection against environmental influences such as, in particular, mechanical stress. In addition, a fastening element, for example a clip, can cooperate with the protective jacket. The protective jacket can then prevent, for example, the line assembly being pinched when the clip is tensioned. In addition, the protective jacket can form insulation to the outside in order to reduce heat or cold loss.

The protective jacket is realized, for example, as a shrink tube and/or comprises a shrink fabric. Such a tube or a protective jacket produced from such a fabric initially comprises a larger diameter than the second line with the first line wound around it. As a result, the protective jacket can be easily slid onto the line assembly. The diameter of the protective jacket is then reduced by the tube or the fabric being shrunk, for example under the influence of heat. The protective jacket then rests flatly on the first and the second line and fixes them relative to one another.

As an alternative to this, the protective jacket can also be realized as a corrugated tube which is displaceable, in particular, relative to the first line. As a result, a high level of pliability or flexibility of the line assembly can be achieved.

In an embodiment, the first line and the second line can be cast with the protective jacket so that they form a positive locking and/or substance to substance bond with the protective jacket. A very robust connection is consequently achieved, the protective jacket also fixing at the same time, where applicable, the first line with reference to the second line.

In addition, at least one heating element, which extends through the first line in the longitudinal direction, can be arranged in the first line. The heating wire provides an improved possibility for heating the medium as heating can occur even before the heating or cooling medium is at a sufficient temperature.

### BRIEF DESCRIPTION OF THE FIGURES

Further features, details and advantages of the disclosure are produced from the wording of the claims and from the following description of embodiments by way of the drawings, in which, in a schematic view:

FIG. 1 shows a perspective view of a line assembly,

FIG. 2 shows a sectional view through the line assembly from FIG. 1,

FIGS. 3a to 3c show different embodiments of the first line; and

FIG. 4 shows a further embodiment of the line assembly.

### DETAILED DESCRIPTION

FIG. 1 shows an embodiment of a line assembly 10. The line assembly 10 comprises a first line 12 which is realized as a UREA line for UREA or a urea solution, and a second line 14 for a gaseous or liquid. The first line 12 is wound around the second line 14 in the circumferential direction U and is thermally coupled with the same. A temperature exchange can consequently take place between the UREA flowing through the first line 12 or the medium flowing through the second line 14 so that the UREA is tempered by the other medium.

The line assembly 10 is used, for example, in a vehicle with an internal combustion engine in order to heat UREA for treating the exhaust gas. UREA is a urea solution which is used to reduce nitrogen oxides in the exhaust gases of the internal combustion engine operated in particular with diesel. The medium can be formed, for example, by hot exhaust gas of the internal combustion engine. As an alternative to this, a different medium can also be used, such as, for example, the cooling water utilized as a rule in the vehicle anyway for the engine waste heat.

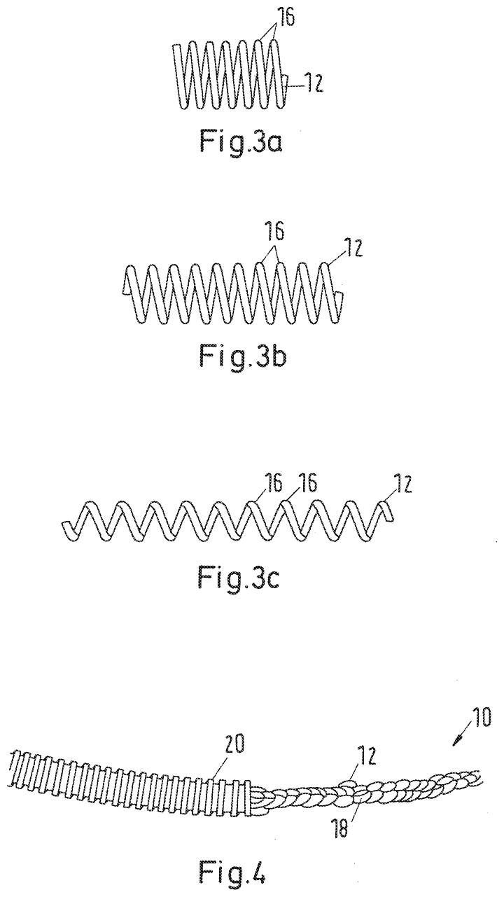

The first line 12 is conducted in a spiral or helical manner, as can be seen, in particular, in FIGS. 3a to 3c, the windings 16 of the first line 12 comprising a constant gradient in each case. In this case, the line 12 can be correspondingly preformed in a spiral or helical manner or not brought into the corresponding spiral form until a winding operation around the second line 16.

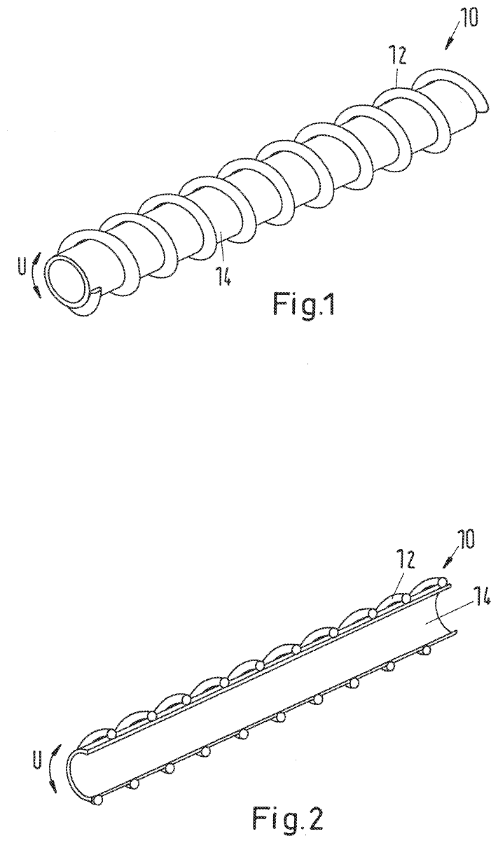

As can be seen in particular in FIG. 2, the second line 14 has a relatively large cross section compared to the first line 12 so that a large medium volume is able to flow through the second line 14. As a result, the medium is able to store a relatively large amount of thermal energy in the second line so that rapid heating of the UREA conducted in the first line 12 is possible.

In addition, the section over which the first line 12 is thermally coupled with the second line is relatively long, so that a temperature exchange can be effected over a relatively long section. As a result, in combination with the large cross section of the second line 14, a very good thermal exchange can be effected between the medium in the second line 14 and the UREA in the first line 12.

The effectiveness of the thermal transmission is additionally dependent on the gradient of the windings 16 of the first line 12. In the case of a larger gradient (FIG. 3c), the number of windings 16 and consequently the section over which the first line 12 is coupled thermally with the second line 14 is shorter than in the case of a small gradient (FIG. 3a). Accordingly, with the same diameter of the first line 12 and the same flow speed inside the first line 12, the time in which a temperature exchange can be effected is shorter. The effectiveness of the thermal exchange can therefore also be adjusted via the gradient of the windings 16 of the first line 12.

The line assembly 10 shown in FIG. 4 corresponds, in principle, to the embodiment shown in FIGS. 1 and 2. A woven fabric 18, which is interwoven with the first line 12 and holds or supports it, is provided in addition. The woven fabric 18 is, for example, a glass-fiber fabric which completely surrounds the second line in the circumferential direction U. To a certain extent, the first line 12 forms a thread of the woven fabric 18, that is to say is interwoven with the woven fabric 18 over the entire length which abuts against the second line 14 so that a displacement of the first line 12 relative to the second line 14 is reliably prevented.

A protective jacket 20, which completely surrounds the line assembly 10, is provided in addition. As a result, the first line 12 and the second line 14 are protected against mechanical stress. In the embodiment shown here, the protective jacket 20 is formed by a corrugated tube. The first line 12 and the second line 14 have play inside said corrugated tube and can therefore move relative to the same, as a result of which the line assembly 10 is relatively flexible and can be easily deformed, in particular bent.

As an alternative to this, the protective jacket 20 can be realized as a shrink tube which abuts directly against the woven fabric 18 and presses the same and the first line 12 against the second line 14. As a further alternative to this, the protective jacket 20 can be injected directly onto the first line 12 and the second line 14 or both lines 12, 14 can be cast into the protective jacket 20.

The disclosure is not restricted to one of the afore-described embodiments but is modifiable in diverse ways.

A heating element, which can heat the UREA additionally, for example during a start phase of the internal combustion engine during which the medium in the second line 14 is still not at a sufficient temperature in order to heat the UREA sufficiently in the first line, can be arranged, for example, in the first line 12 as an option.

Multiple first lines 12 for UREA, which are preferably arranged distributed uniformly on the outer circumference of the second line 14 according to an embodiment, can be provided in addition. For example, the first lines 12 are then wound around the second line 14 in each case with the same gradient.

All features and advantages emanating from the claims, the description and the drawing, including structural details, spatial arrangements and method steps, can be essential to the invention both on their own per se and in the most varied combinations. It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

### LIST OF REFERENCES

10 Line assembly

12 First line

14 Second line

16 Windings of the first line

18 Woven fabric

20 Jacket

U Circumferential direction

1. A line assembly having at least one first line, which is realized as a UREA line, and having a second line for a liquid or gaseous medium, wherein the first line and the second line are thermally coupled together, wherein the first line is wound around the second line or the second line is wound around the first line.

2. The line assembly as claimed in claim 1, wherein the second line comprises a greater diameter than the first line, wherein the diameter of the second line is more than double the diameter of the first line.

3. The line assembly as claimed in claim 1, wherein the first line is wound in a spiral or helical manner around the second line.

4. The line assembly as claimed in claim 1, wherein a woven fabric, which holds the first line on the second line, is provided.

5. The line assembly as claimed in claim 4, wherein the first line is interwoven with the woven fabric.

6. The line assembly as claimed in claim 4, wherein the woven fabric is a glass-fiber fabric.

7. The line assembly as claimed in claim 1, wherein a protective jacket, which surrounds the first line and the second line, is provided.

8. The line assembly as claimed in claim 7, wherein the protective jacket is realized as a shrink tube and/or comprises a shrink fabric.

9. The line assembly as claimed in claim 7, wherein the protective jacket comprises a corrugated tube.

10. The line assembly as claimed in claim 7, wherein the first line and the second line are cast with the protective jacket.

11. The line assembly as claimed in claim 1, wherein at least one heating element, which extends through the first line in the longitudinal direction, is arranged in the first line.

12. The line assembly as claimed in claim 1, wherein the second line comprises a diameter greater than the first line, wherein the diameter of the second line is more than four times the diameter of the first line.

13. The line assembly as claimed in claim 1, wherein the second line comprises a diameter greater than the first line, wherein the diameter of the second line is more than eight times the diameter of the first line.
